(19) United States
(12) Patent Application Publication
(10) Pub. No.: US 2016/0355018 A1
(43) Pub. Date: Dec. 8, 2016

(54) INK JET PRINTER WITH MAINTENANCE UNIT

(71) Applicant: Océ-Technologies B.V., Venlo (NL)

(72) Inventor: Johannes B.M. SEVENICH, Venlo (NL)

(73) Assignee: Océ-Technologies B.V., Venlo (NL)

(21) Appl. No.: 15/170,279

(22) Filed: Jun. 1, 2016

(30) Foreign Application Priority Data
Jun. 8, 2015 (EP) 15171060.5

(51) Int. Cl. B41J 2/165

(52) U.S. Cl. CPC B41J 2/16535

(57) ABSTRACT

An ink jet printer having a print head, an ink collector arranged to collect ink that is jetted out from the print head in a non-printing mode, a maintenance unit and a liquid supply system for supplying an operating liquid to the maintenance unit, comprising a recirculation system connecting the ink collector to the liquid supply system for supplying collected ink as the operating liquid to the maintenance unit.

The invention relates to an ink jet printer having a print head, an ink collector arranged to collect ink that is jetted out from the print head in a non-printing mode, a maintenance unit for the print head, and a liquid supply system for supplying an operating liquid to the maintenance unit.

U.S. Pat. No. 6,367,905 B1 discloses an ink jet printer of this type, wherein ink droplets are continuously jetted out from nozzles in a nozzle face of the print head. When a droplet that has left the nozzle is to be used for forming a mark on a recording medium, this droplet is electrostatically deflected so that it will hit the recording medium at the intended position. When the droplet is not to be used for printing, it is deflected into the collector. The ink that has been collected in the collector is then recirculated to the print head so that it may be used again for forming ink droplets.

The maintenance unit includes components such as wipers, sponges, doctor blades and the like for cleaning the nozzle face of the print head from time to time. Some of these components need to be kept wet in order to function properly. The liquid supply system is provided for supplying a cleaning liquid that is different from the ink, to the maintenance unit for wetting the components of the maintenance unit. The used cleaning liquid is also collected and recirculated to the maintenance unit.

Another maintenance unit including a cleaning liquid recirculation system is disclosed in EP 2 492 097 A1.

In an ink jet printer of the drop-on-demand type, all droplets that are jetted out from the print head in a normal printing operation are directed onto the recording medium. However, ink droplets may also be jetted out in a non-printing mode, for example for preventing the nozzles from drying-out when the print head is not used. In this case, the collector will collect the droplets that have been jetted out in the non-printing mode. The collected ink will then be discharged into a waste ink container.

It is also known to use fresh ink, especially water-based ink, for wetting components of the maintenance unit. In this case, ink droplets are jetted-out from the print head directly onto the components to be wetted, and the used ink dripping off from these components will also be collected and discharged.

It is an object of the invention to provide an ink jet printer wherein resources can be utilized more efficiently.

In order to achieve this object, according to the invention, an ink jet printer of the type described in the opening paragraph comprises a recirculation system connecting the ink collector to the liquid supply system for supplying collected ink as the operating liquid to the maintenance unit.

Thus, the used ink that has been jetted out from the print head in the non-printing mode is not discharged but is re-used for wetting components of the maintenance unit. In this way, the consumption of ink can be reduced and the amount of used ink to be discharged is decreased.

In an embodiment, the maintenance unit comprises a wiping unit. Non-limiting examples of wiping units are wiper blades, tissue wipers, sponges and doctor blades. These wiping units may be configured to clean the surface of a nozzle surface of a print head. These wiping units may show improved cleaning efficiently if they are wetted during and/or before contacting the nozzle surface of a print head. The maintenance unit may further comprise a cleaning member configured for cleaning the wiping unit.

More specific optional features of the invention are indicated in the dependent claims.

Embodiment examples will now be described in conjunction with the drawings, wherein:

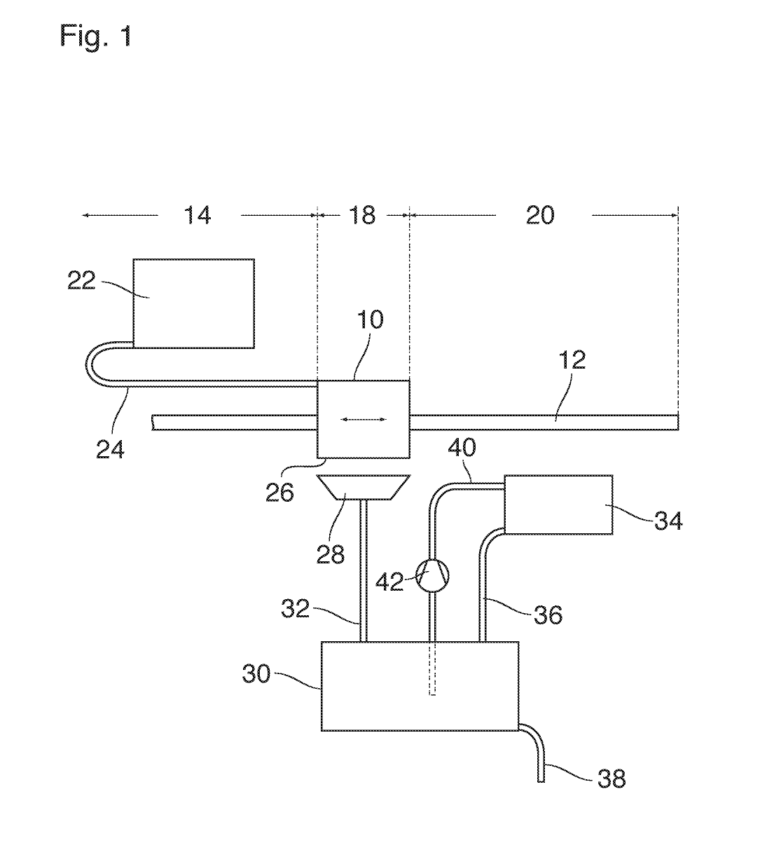

FIG. 1 is a block diagram of essential components of an ink jet printer according to the invention; and

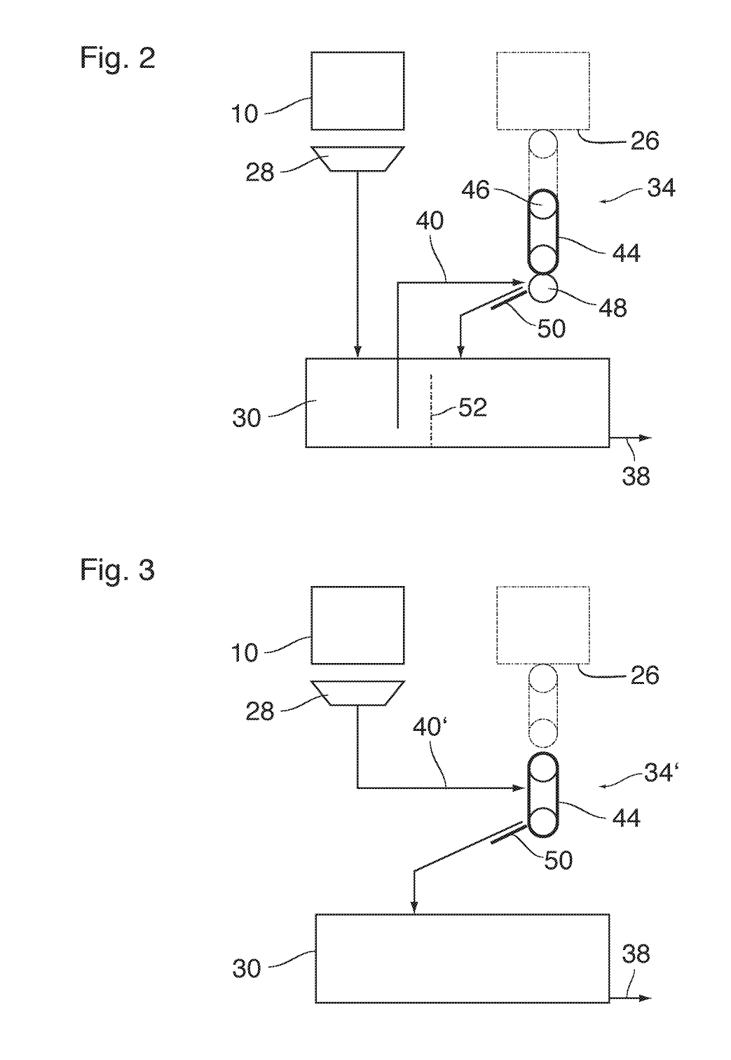

FIGS. 2 and 3 are diagrams illustrating different embodiments of the invention.

As is shown in FIG. 1, an ink jet printer has a print head 10 arranged for a reciprocating movement along a guide rail 12. The length of the guide rail 12 is divided into an operating zone 14, a home position 18 and a maintenance zone 20.

An ink supply system 22 is provided for supplying fresh ink, e.g. water-based ink, to the print head 10 via a flexible tube 24. The print head has a nozzle face 26 containing an array of nozzles (not shown) for jetting out droplets of ink.

During a normal print operation the print head 10 reciprocates in the operating zone 14, and the nozzles are energized at suitable timings such that the ink droplets jetted out from the nozzles form an image on a recording medium (not shown) that passes through underneath the operating zone 14 of the guide rail. In this example, the printer is of the drop-on-demand type, so that, when the print head is moving in the operating zone 14, the nozzles are energized only when an ink droplet is actually needed for forming a mark on the recording medium.

In FIG. 1 the print head 10 has been shown in the home position 18 to which it is moved when the print operation is stopped or paused. When the print head 10 is not operating and rests in the home position 18, there is a risk that the ink in the nozzles dries out, so that the nozzles become clogged with dried ink and will not function properly any longer. In order to prevent this, the nozzles are fired from time to time so as to “spit” ink droplets in a non-printing mode. These droplets are collected in a collector 28 that is disposed underneath the nozzle face 26 of the print head in the home position. The collected ink will then be drained into a waste ink container 30 via a line 32.

From time to time, the print head 10 is moved to the maintenance zone 20 where a maintenance unit 34 is provided for performing certain maintenance operations such as purging the nozzles of the print head, wiping the nozzle face 26 in order to remove dust and other contaminants, and the like. As is generally known in the art, the maintenance unit 34 comprises wiper members in the form of sponge bodies, wiper rollers or wiper belts, which are lifted against the nozzle face 26 and moved relative to the print head 10 so as to wipe over the nozzle face. Since, in the course of time, these wiper members will themselves becomes stained with contaminants, the maintenance unit 34 includes also components for cleaning the wiper members, e.g. transfer rollers, scrapers, and the like. At least some of the components of the maintenance unit 34 should be kept wet in order to function properly. It is therefore convenient to use fresh ink that is discharged from the nozzles of the print head 10 for wetting these components of the maintenance unit. The waste ink that is generated in this way in the maintenance unit 34 is also discharged into the waste ink container 30 via a line 36.

As waste ink will gradually accumulate in the waste ink container 30, a discharge line 38 is connected to the container 30 for discharging the waste ink either continuously or batch-wise.

In the example shown in FIG. 1, a recirculation line 40 and a pump 42 are arranged for sucking a part of the waste ink from the container 30 and recirculating it to the maintenance unit 34. Thus, this part of the waste ink can be re-used for wetting certain components of the maintenance unit 34 rather than being discharged directly. Optionally, the waist container 30 may contain a filter (not shown) to remove particles or impurities before re-entering the system. Optionally, line 40 may contain a filter (not shown) to remove particles or impurities from the waist ink.

In the example shown in FIG. 1 it is assumed that the print head 10 is provided for printing with ink in only a single colour. In a multi-colour ink jet print head, a plurality of print heads 10 will be provided, at least one for each colour, and ink supply systems, ink collecting systems and maintenance systems equivalent to what is shown in FIG. 1 will be provided separately for each of these print heads.

As an illustrative example, some parts of the maintenance unit 34 has been shown in greater detail in FIG. 2 together with the print head 10, the collector 28, the waste ink container 30 and the recirculation line 40 which, together with the pump 42, constitutes a recirculation system for recirculating waste ink to the maintenance unit 34. In this example, the maintenance unit comprises an endless wiper belt 44 trained over two rollers 46 at least one of which is driven for rotation.

The entire maintenance unit 34 is adapted to be lifted into a position where the part of the wiper belt 44 that runs over the upper roller 46 contacts the nozzle face 26 of the print head 10 when the latter is in a position within the maintenance range 20, as has been shown in phantom lines in FIG. 2. Then, by driving the wiper belt 44 and simultaneously moving the print head along the guide rail 12 relative to the maintenance unit 34, the entire surface of the nozzle face 26 can efficiently be wiped clean. Before the wiping operation starts, some or all nozzles of the print head may be fired in order to jet out fresh ink that will serve to wet the wiper belt 44.

The lower one of the rollers 46 forms a nip with a transfer roller 48 which is provided for removing contaminants from the surface of the wiper belt 44 so as to prevent the wiper belt from becoming stained in the long run and then re-soil the nozzle face 26. The transfer roller 48 must also be kept wet. However, rather than using fresh ink from the print head 10, the ink that is used for wetting the transfer roller 48 is waste ink that is recirculated from the waste ink container 30 via the recirculation line 40.

The peripheral surface of the transfer roller 48 is engaged by a blade 50 which has the purpose to remove the contaminants from the surface of the transfer roller. The recirculation line 40 is arranged to supply waste ink onto a portion of the peripheral surface of the transfer roller 48 immediately above the blade 50, so that the contaminants will be washed away with the recirculated ink which will then run down the blade 50 and drip into the waste ink container 30 (or into a separate intermediate container provided for that purpose).

In the example shown, a filter or baffle 52 divides the interior of the container 30 into two compartments, one of which receives the ink from the collector 28 whereas the other one receives the ink returning from the maintenance unit 34. In this way, the contaminants contained in the liquid from the maintenance unit 34 are prevented from re-entering into the system. The discharge line 38 is connected to the compartment that receives the ink from the maintenance unit 34, and the baffle 52 forms a spillover permitting excess ink from the collector 28 to be discharged as well.

FIG. 3 illustrates an embodiment having a modified maintenance unit 34′ and a recirculation system constituted by a recirculation line 40′ that connects the collector 28 directly to the maintenance unit 34. When the maintenance unit 34 is in the lower position, the waste ink from the collector 28 may flow to the maintenance unit under the action of gravity, so that a pump may be dispensed with.

The maintenance unit 34′ contains only the wiper belt 44. The recirculation line 40′ is arranged to wet this wiper belt directly. If necessary, additional ink may be supplied from the print head 10. The blade 50 is arranged to engage the surface of the wiper belt 44 for removing the contaminants from the belt, so that no transfer roller is needed.

Of course, the maintenance unit 34′ shown in FIG. 3 may also be used in combination with the recirculation system shown in FIG. 2, and vice versa.

1. An ink jet printer having a print head, an ink collector arranged to collect ink that is jetted out from the print head in a non-printing mode, a maintenance unit and a liquid supply system for supplying an operating liquid to the maintenance unit, characterized by a recirculation system connecting the ink collector to the liquid supply system for supplying collected ink as the operating liquid to the maintenance unit.

2. The printer according to claim 1, wherein the recirculation system comprises a waste ink container connected to the collector and a recirculation line connecting the waste ink container to the maintenance unit.

3. The printer according to claim 1, wherein the recirculation system comprises a recirculation line that connects the collector directly to the maintenance unit.

4. The printer according to claim 2, wherein the recirculation line includes a pump.

5. The printer according to claim 1, wherein the maintenance unit includes a wiper member and a cleaning member for cleaning the wiper member, and the recirculation system is arranged to supply ink to the cleaning member.

6. The printer according to claim 1, wherein the maintenance unit includes a wiper member and the recirculation system is arranged to supply ink to the wiper member.

7. The printer according to claim 5, wherein the print head is arranged to be moved into a position where it is capable of jetting-out fresh ink onto the wiper member.
